(19) United States
(12) Patent Application Publication
(10) Pub. No.: US 2003/0130864 A1
(43) Pub. Date: Jul. 10, 2003

(54) Facilitation of mobile direct response by service callback

(76) Inventors: Edwin Kong-Sun Ho, Palo Alto, CA (US); Lauren Bigelow, Acton, MA (US); Derek Alexandre Proudian, Woodside, CA (US)

Correspondence Address: Christian A. Nicholes, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/044,448

(22) Filed: Jan. 9, 2002

(51) Int. Cl. G06F 17/60

(52) U.S. Cl. 705/1

(57) ABSTRACT

A system for the facilitation of direct response to conventional advertising and other media, initiated by a mobile subscriber to a wireless network, using a dial keypad on a mobile device, is disclosed. The system allows the subscriber to easily reply to a call to action and to be engaged in a dialogue with a service server or representative in a manner that dynamically matches the capabilities of the subscriber's device and the service requested. The system is implemented without any modifications to the wireless device or network.

### FIELD OF THE INVENTION

The present invention relates to facilitating of the initiation and delivery of services delivered on mobile terminals.

### BACKGROUND OF THE INVENTION

The mobile phone has become a ubiquitous feature of modem life. The ability to be reached and to reach others has proven to be of compelling value that has led to rapid adoption. The ability to have a personal phone wherever one is located and the ability to connect whenever one desires is valuable. Upgrades to mobile networks and devices have brought a new series of features. In Europe and Asia, the upgrade to the Global System for Mobile Communications (“GSM”) standard brought short message service (“SMS”) to the mobile phone subscriber base in the early 1990s. Since then, SMS messaging has been measured in the billions per month and, for some, is the most popular use of the phone. Recent upgrades to the U.S. cellular network support 2-way SMS, and increasing use is being observed as handsets capable of using the service are being rolled out.

New capabilities are being added to mobile networks and phones. Many phones now include Wireless Application Protocol (“WAP”) browsers that allow interactive data services. Other phones support downloadable and animated Java applications that can both execute on the mobile device and also interact with the network. Other phones, by manufacturers such as Kyocera, include an embedded Personal Digital Assistant (“PDA”). Large investments are being made in higher bandwidth networks, extending the digital “second generation” (“2G”) networks to full “third generation” (“3G”) and intermediate (“2.5G”) networks, at enormous costs to the mobile operators for infrastructure and spectrum. The promises of these networks to subscribers are new services and, to operators, new income sources based on digital services. One source of income comes from enabling companies to better communicate and serve their customers by exploiting the personalized nature of the mobile device as well as the time-and-place relevance of a device that is always on and always with the customer. Such a device provides the capability to directly respond to advertising using embedded “calls to action.” Both the increased usage of the voice and data capabilities and the advertising and commerce revenues from these companies form a major source of new income to economically justify the deployment of these networks.

Yet, several problems exist in the adoption of new digital services by consumers. Although most phones sold today have digital services such as two-way SMS and/or WAP browsers, most users do not use these features due to four problems: difficulty of use, lack of stimulation, limited features, and economics. First, the most widely used mobile devices are cellular telephones, which have a keypad interface designed to dial numbers and execute limited menu selections, such as accessing a stored number list. Although the keypad interface is used to initiate text messages and may use an embedded browser, getting to these features may require making multiple menu entries to start the service. Entering a uniform resource locator (“URL”) on the phone dial keypad may be a difficult task because, for example, punctuation used in the URL, such as a period, is not presented on the keypad. Second, the digital services, advertising or commerce opportunities that are presented on these devices as stimulation are limited to the number of users of the stimulation media and the limited engagement of the stimulation media. The bulk of advertising dollars are spent on engaging consumers with visually and aurally rich images, video and sound; features which may not exist on current mobile cell phones. Third, the lack of compelling stand-alone applications on the “Wireless Internet” has resulted in limited adoption of direct response mechanisms. And finally, in many areas of the world, the initiator of a message pays; even a call to a land line toll-free number is charged as a mobile call, and sending an SMS to a merchant is a chargeable event. Inbound, unsolicited voice calls from a merchant are illegal in certain areas such as the United States, and inbound text and multimedia messages are limited due to the user perception of spam and privacy issues, as well as emerging legislation. All of these factors slow the adoption of an ideal direct response device.

Some solutions have been suggested to inform a user and connect a user to a wireless site. It is standard procedure in the industry for a mobile carrier to maintain a home portal page that appears on the cell phone when the browser connects. This portal lists limited sites and categories, but is clearly only used by the limited few who access the mobile Internet, and is also limited to the sites listed in the portal. Wireless advertising on the portal sites and other sites is being initiated, but the sparse audience again limits the reach of the advertising and its engagement by the capabilities of the handset. Recent guidelines by the Wireless Advertising Agency for unsolicited advertising “pushed” to the receiver have been well received, but spam from non-participating companies will likely lead to legislative limitations.

Some services and companies use existing media to stimulate users to reply. U.S. Pat. No. 6,021,432, issued to Sizer, et al., suggests embedding signals in audio or video broadcasts that are imperceptible by a human and having the phone detect these signals to link to a website. This approach requires modifications to the handset.

Yet, the use of wireless devices to respond to media stimuli is evidenced by the rise of Direct Response TV (TV commercials with 800 numbers) coincident with the arrival of the cordless phone in homes and the phone's availability near the TV. Furthermore, the recent increased display of phone numbers in outdoor and radio advertisements may be due to availability of cellular phones. Simple dialing schemes have evolved to the point that special key sequences exist for emergency (911) and information (411). Cellular companies sometimes sell short sequences of such dialed numbers. For example, one cellular company, Starcd, is named after the use of the characters “*cd” dialed by a cell phone user to be connected to an Interactive Voice Response System (“IVR”) to buy compact discs that have been played on a radio station. The sequence “#121” is used by AT&T to connect to a voice service.

The use of simplified sequences to connect to Internet sites has been addressed in U.S. Pat. No. 6,061,738, issued to Osaku, et al., which discusses a process used to allow simple number or letter sequences to be mapped to complex URLs, easing the entry of complex addresses for devices having simplified keyboards. That process intercepts a operating system (“OS”) message and replaces an OS messaging callback function with an OS message in which a simplified network address entered by the user replaces an address that corresponds to a complex URL. This approach works well with a higher order OS where a programming environment with application programming interfaces (APIs) exist for the developer. However, the ability to change the computer code in a dedicated mobile device such as a cell phone may be limited to the manufacturer and may only be available on future devices; it cannot be used for existing cell phones or other devices with less OS sophistication or programmability. Furthermore, that approach utilizes the data viewing application (e.g. a browser) and the same data network for determining the replacement URL; in effect, the device needs to be in data mode to view the desired information, only partially simplifying the use of the device. Finally, the mapping from a simplified network address to a URL does not take into consideration the capabilities of the device; the above process may be appropriate for a personal computer browser application, but not for mobile devices with different messaging or browsing capabilities, nor for choices of data or voice services provided to the mobile subscriber.

The normal use of the dial pad is to make phone calls. However, to avoid high international tariffs the dial pad and the network are used to signal a telephony system to “call back” the user and request the dialed number. The user dials a number that is unique to him, or the number from which he is dialing is detected using the digital signaling properties of the telephone network. U.S. Pat. No. 5,661,790, issued to Hsu, discloses how a digital signaling system can signal a distant switch to return the user's call. This approach of using the dial pad to initiate a voice communications service is now commonplace and used by operators in their callback services. To date, these uses have been limited to voice phone calls with another user to reduce communications costs.

Some efforts have been made to simplify the creation of a response using a data network and a mobile device. U.S. Pat. No. 6,304,753, issued to Hartmaier, discloses how a network platform can support the use of the keypad and the voice network signaling capability to request information in a digital format. A service node is added to the infrastructure of a digital wireless network. The service node can respond to a number dialed by an end subscriber by terminating the call and requesting a reply from an information server. The service node looks up the data address of the subscriber in a database available only to the wireless network operator and sends the one way text or multimedia message received by the information server to the user. However, this approach only supports a single reply to the request; it does not set up a two-way dialogue with the user and the information server. Furthermore, this approach assumes that all phones are data-push capable and that such data delivery rather than voice capability is desired for all service replies. A system supporting mixed users with analog connections in a rural area may preclude text-only messaging and non-web-browsing phones. A service which chooses to respond to a user with a voice call is also precluded in such a system. The service used by this approach also allocates a distinct number to each service and does not allow the appending of information to a generic service that could describe a particular product, a specific location, or other information entered by the user to specify the service. Deployment of a service node in each operator's network is a barrier to deployment of a direct response service; for example, in Hong Kong, there are 6 wireless operators, some using different manufacturers' network hardware. A mass adoption service independent of the operator is important to the service. Additionally, the presence in that approach of an intermediate node that is required to forward all messages, rather than a node that simply sets up communications directly with the information server, as is common place in data networks such as the Internet, presents a scalability issue. Finally, the service of this approach is not integrated into a larger campaign and call to action in a different media that is typical of direct response advertising.

### SUMMARY OF THE INVENTION

A call from a mobile device is received. A response to the called is selected based upon information selected to address the call. A dialog between a server and the mobile device is initiated.

### BRIEF DESCRIPTION OF THE DRAWINGS

These and other aspects of the invention will be better appreciated when taken in conjunction with the detailed description and accompanying drawings, in which:

FIG. 1 is a block diagram of the components in one embodiment of a system that provides mobile service callback;

FIG. 2A is an illustration of a printed advertisement with a call to action, according to one embodiment;

FIG. 2B is an illustration of the components of a mobile device used to initiate the service through which a mobile device is connected to a two-way data dialogue through the action of a return data message in one embodiment;

FIG. 3 is a flow diagram depicting one embodiment of a process of a mobile subscriber initiating and using the mobile service callback;

FIG. 4 is a flow diagram depicting one embodiment of a process performed by the Computer Telephony Integrated (“CTI”) and the push server components to connect a mobile device to a two-way dialogue through the action of a return data message;

FIG. 5 is a flow diagram depicting one embodiment of a process performed by a service server to connect a mobile device to a two-way dialogue through the action of a return data message; and

FIG. 6 is a flowchart depicting an embodiment of the operation of the service through which a mobile device is connected to a two-way data dialogue through the action of a return data message.

### DETAILED DESCRIPTION

In the following description, numerous details are set forth, such as distances between components, types of molding, etc. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the mechanisms used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

A method and components are described herein to use a mobile device to provide direct response to calls to action that have been presented to a mobile subscriber in a variety of media and to create a direct two-way dialogue with a service server that is associated with the sponsor of that call to action. A mobile subscriber is enabled to use the numeric keypad of the mobile device, in a manner similar to making a phone call, to be connected to a two-way data and/or voice dialogue through the action of a return data message. Dynamic choice and creation of the format of the dialogue is supported to be consistent with the capabilities of each mobile subscriber's mobile device, the desires of the service, and the network capabilities. These formats include, but are not limited to, text messaging, Internet connectivity-using protocols such as WAP, Interactive Voice Sessions, and direct voice connections to an operator.

In one embodiment, a series of components are utilized that are present and accessible to third parties in a mobile network. These components facilitate the creation and delivery of services and exist in many digital Wireless Networks. These include gateways between different digital networks such as the Internet and digital wireless transport and addressing systems such as WAP and SMS. These capabilities allow an external provider to address a message to a subscriber's wireless ID (e.g., his phone number) without knowing the digital address or details of the subscriber (e.g., a temporary IP address). Servers, such as Voice Extensible Mark Up Language (“VMXL”) servers, sit between a Public Switched Telephony (“PSTN”) network and the Internet to provide functionality in addition to gateway capability, but also provide features such as text-to-speech and Dual Tone Multi-Frequency (“DTMF”) detection. By using existing features such as Short Message Service Centers (“SMSC”) present in most operator's networks and external components, the service can achieve mass utilization independent of the mobile subscriber's choice of operator. Computer Telephony Integrated (“CTI”) servers are utilized to accept the request from the mobile subscriber. A push server is used to initiate a digital conversation with the service server, which is utilized to fulfill the requirements of the call to action. The push server both establishes the mode of the subsequent conversation with the service server and sets the session up with the service server, but can easily scale to large number of users.

In one embodiment, the system provides facilitation of direct response to print on product, outdoor, radio and TV advertising, and also provides the ability to include information in the initial response relative to a specific product, location, or individual. By enabling direct response to the user with the simplicity of making a voice phone call, and by enabling direct response to the advertiser with the full digital capabilities of existing and emerging devices and networks, significant advantages are provided to both consumers and businesses.

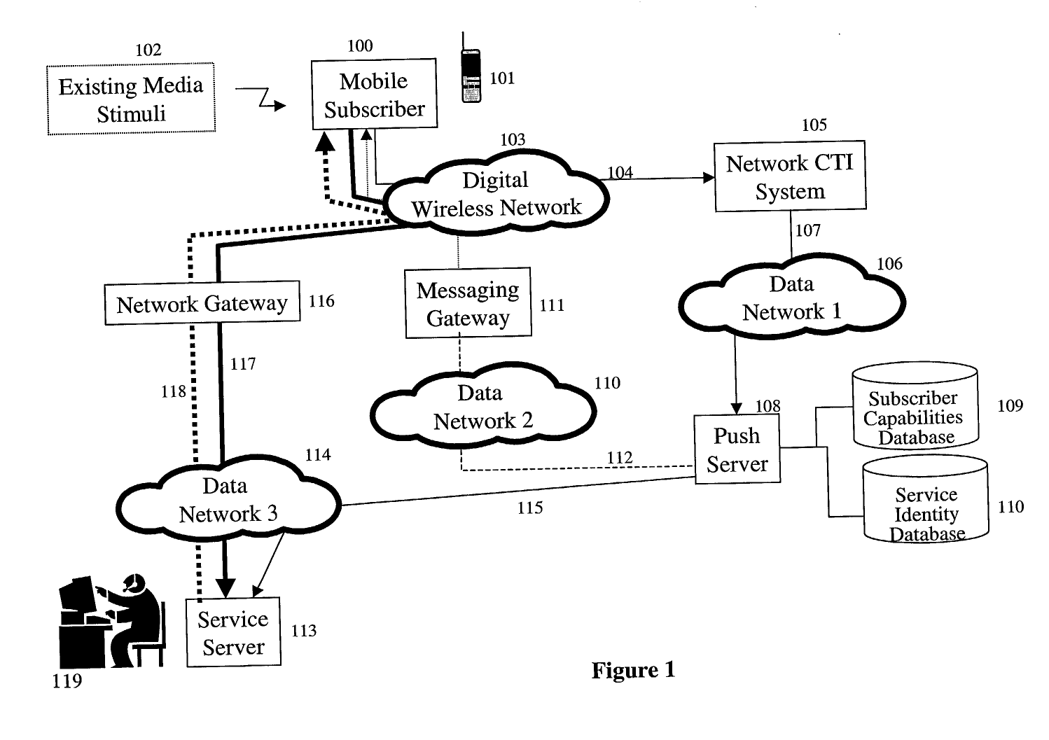

One embodiment of a system for enabling mobile services through callback is shown in FIG. 1. As shown in FIG. 1, the system preferably comprises a mobile subscriber 100, with a mobile device 101, responding to external media stimuli 102. A service to connect a mobile device to a two-way dialogue through the action of a return data message is provided by a Network Computer Telephony Integrated (“CTI”) system 105, a push server 108 and one or more service servers 113. These three components are illustrated as distinct due to their functionality, but an alternate embodiment may combine two or more of these components.

These components communicate between themselves through a series of networks that may be distinct or where two or more may be identical, comprising a digital wireless network 103 and three networks used for digital communications, designated as data network 1, 106; data network 2, 110; and data network 3, 114. The digital networks are bridged by a set of gateways comprising a messaging gateway 111 and a network gateway 116, and by CTI system 105 and push server 108 that have access to multiple networks and which can either access these networks independently or act as gateways in reformatting and re-addressing messages between other systems. The gateways are functions of and are provided and maintained by the network operators. They also provide address translation. For example, commercially accessible SMS gateways allow a server to address a message to a cellular handset with the Mobile Identification Number (MS) of the user and the gateway will then readdress the message to ensure delivery in the digital wireless network. For WAP push, the WAP gateway will need to obtain the temporary IP address on the handset and deliver a message addressed to the permanent MIN or other unique designator of the mobile device, and perhaps relay back the temporary IP address used for routing. In this manner a service server using these gateways is removed from the details of cellular routing and addressing.

Gateways 111 and 116 can also provide additional features that assist in the execution of the service such as translation, compression, expansion and security, and are well known features to those skilled in the art of communications services. These include, but are not limited to, Short Message System Gateways (“SMS”), e-mail servers, Wireless Mark Up Language (“WML”) gateways and Voice Extensible Mark-Up Language (“VXML”) servers.

Service server 113 refers to any platform used to manage a service with a mobile subscriber 100 and includes but is not limited to services deployed with web servers, application servers, and CTI servers. Service server 113 may also include one or more human representatives 119 who can communicate directly to mobile subscriber 100 through any of the mechanisms available through the device, including but not limited to voice, SMS, Wireless Applications Protocol (“WAP”) chat or collaboration and e-mail. Service server 113 may communicate directly to the human representative through a digital screen or voice interface or through a system that manages multiple human representatives such as a call center or digital work group.

In one embodiment, digital wireless network 103 includes a wireless network that can be used to transport voice. Digital wireless network 103 may also include components of the PSTN and the transport and signaling associated with these networks. It may also include all of the transport and signaling of any emerging packet communication networks used in the set up of a voice phone call that includes, but is not limited to, Asynchronous Transport Mode (“ATM”) and Voice Over Internet Packet (“VOIP”) networks. Mobile subscriber 100 is any user of mobile services who has subscribed to a carrier or operator of digital wireless network 103, or a reseller of the same.

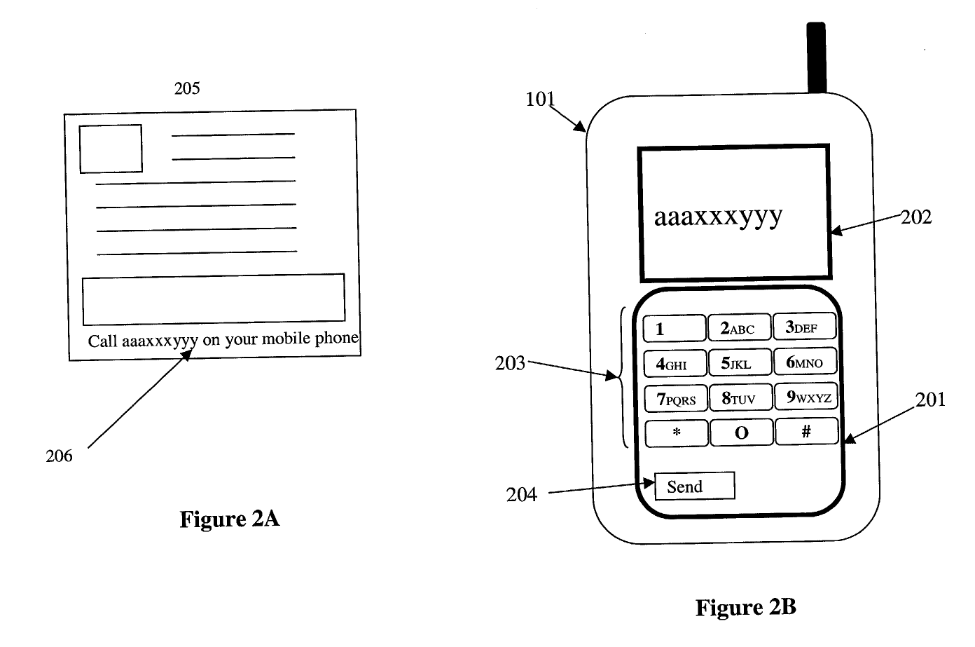

One embodiment of mobile subscriber 100 using mobile device 102 to initiate the service is now described in connection with FIG. 2. The elements of mobile device 101 utilized to establish the service connections in one embodiment are illustrated. In one embodiment, mobile device 100 is a cellular telephone. In other embodiments, it may be a Personal Digital Assistant (“PDA”) or other form of computer with a wireless connection that is used for voice communications. Keypad area 201 encloses a set of keys that are used to establish a voice telephone call. Screen 202 is used to display the number dialed by subscriber 100. Keypad area 201 contains a set of keys to create a voice phone call as well as special purpose keys common in mobile handsets for other features such as voicemail and screen navigation. The keys used in the creation of the service are numeric dial keypad 203 and send button 204. In one embodiment, these buttons are hard buttons. In alternate embodiments, mobile device 101 is a fully screen based device and these buttons are touchscreen soft buttons. In yet another embodiment, voice recognition is used to enter numbers into mobile device 101. In one embodiment, this entry is identical to the methods that mobile subscriber 100 uses to establish a voice communication.

Mobile subscriber 100 is exposed to external stimuli 102 that have an embedded call to action. One embodiment utilizes a print ad 205, shown in FIG. 2A. Print may include traditional advertising placed in newspapers, magazines or other mass circulated print media, direct response material delivered to one or more individuals, and cards or brochures individually handed-out or made available for distribution. Alternate embodiments include the stimuli taking the form of multiple media used to communicate to the public. The stimuli can be any of a series of advertising, marketing and communication formats. These include the traditional advertising media of radio, TV, and publicly viewed advertising (known as outdoor advertising in the industry). The outdoor advertising stimuli include print or electronic signage that are viewed by large numbers of people, such as printed or electronic posters, billboards, kiosks, and other forms of messaging visible to more than one person. The stimuli may be placed outdoors, in public places such as airports, or inside stores or other business establishments. In other alternate embodiments, the stimuli may take the form of emerging media viewed through the wired or wireless Internet, live or through messaging such as e-mail, either as a type of standalone ad or as embedded into other content.

To support direct response, stimuli 205 includes a call to action 206 with an embedded number or character string that can be entered into a mobile device through dial keypad 203, in a manner similar to the manner in which a phone number would be entered. This character string (“characters” herein including numbers) will be referred to herein as the “service dialed number,” as the use by mobile subscriber 100 is similar to the entry and sending of a traditional telephone number dialed with a cellular or mobile phone. The service dialed number may be specific to the stimuli and associated response. In one embodiment, the service dialed number is of the form “aaaxxxyyy” and may contain three parts. The letters “aaa,” “xxx,” and “yyy” as used herein are intended to be representative of plurality of characters, not limited to three, that are letters or numbers present on the dial keypad.

The first part or segment, “aaa,” represents a unique code used by the mobile operator to route the call to a point associated with the service and described subsequently. In one embodiment, this part consists of the code “*88.”

The second part of the string, “xxx,” is a unique code that identifies the service and is used subsequently to allow mobile subscriber 100 to reach and interact with the service associated with the stimuli.

The last segment, “yyy,” is an optional field that provides information unique to the stimuli. In one embodiment, this last segment can represent a physical location of a stimulus, such as a mall or store or other location. In another embodiment, this segment may be associated with a specific product and used to select a prize as part of a promotion or accumulate points associated with purchase of that product. In yet another embodiment, this segment may refer to a specific individual or group of individuals and provide information relevant to that individual or the group or provide connectivity to that individual or the group. For example, the segment may allow the subscriber to join a group that receives messages about a favorite sports team, or receive a callback from an individual or work group.

The stimulus, call to action, and service dialed number is delivered in a format appropriate to the capabilities of the media. In one embodiment, the stimulus, call to action, and service dialed number are delivered through print, as illustrated in FIG. 2. In other embodiments, using other media, delivery can be through voice, video or electronic display, or a combination of these, as appropriate. For example, direct response TV uses a human voice to reinforce an 800 number that is displayed on the video TV display.

In one embodiment, the service, through which a mobile device is connected to a two-way data dialogue through the action of a return data message, is initiated by the following actions. Mobile subscriber 100 with mobile device 101 is exposed to external media stimulus 102. Included in stimulus 102 is call to action 206 with an embedded service dialed number. Subscriber 100 enters the service dialed number on mobile device 101 using standard dial keypad 203 and presses send button 204. In one embodiment, services are included in which the subscriber adds the service dialed number to his phonebook. This allows bookmarking of the service using the standard mobile device phone book for later use.

One embodiment of the functionality of the system is described with reference to FIG. 1. Upon pressing send button 204, mobile subscriber 100 initiates a voice phone call to the service dialed number “aaaxxxyyy.” Digital wireless network 103 recognizes the prefix “aaa” and routes via path 104 to network CTI system 105. For example, “aaa” may be comprised of a dial sequence “*88.”

In one embodiment, the CTI system 105 is connected to the digital PSTN (e.g., an Integrated Services Digital Network (“ISDN”) Primary Rate Interface (“PRI”)) via a digital signaling trunk that passes both caller and calling information and call control to CTI system 105 in a manner well known and documented to those skilled in the art of digital PSTN networks. In alternate embodiments, mobile device 101 communicates over a packet voice network, with a services management protocol such as the Session Initiation Protocol (“SIP”) or a network softswitch with programmable APIs that passes the equivalent caller and calling information, and provides the service call control. In yet another embodiment of the network, digital wireless network 103 or associated PSTN sends the call into a VOIP gateway, managed by a service protocol such as SIP, or a network softswitch with programmable APIs. Included in the signaling information of the call is the dialed number and the identity of the subscriber, referred to herein as the subscriber identifier. Usually, the subscriber will be the caller. In one embodiment, the subscriber identifier is the subscriber's mobile phone number such as the Mobile Directory Number (“MDN”). In alternate embodiments, the subscriber identifier is a number associated with the subscriber that is unique to the subscriber, such as the Mobile Identification Number (“MIN”).

Network CTI system 105 receives the service dialed number and the subscriber identifier and then signals the telephone network, comprising of digital wireless network 103 and the PSTN, to drop the call before answering. From mobile subscriber's 100 perspective, in one embodiment, mobile device 101 returns to a rest state after completing the (failed) call. Network CTI system 105 signals the event corresponding to the received call to push server 108 via path 107 through data network 1, 106. Push server 108 receives both the service dialed number and the subscriber identifier from network CTI system 105. The push server then uses this information to query subscriber capabilities database 109 as to the capabilities of the mobile device 101 of subscriber 100. These capabilities may include, but are not limited to, whether mobile device 101 is capable of receiving text messages, sending text messages, multimedia messaging, or browsing the Internet. These capabilities may also include the protocol used, or advanced service support, such as Java.

Push server 108 also queries a service identity database 110 with the service dialed number to determine the type of services supported; for example, to determine whether the service supports text messaging or more sophisticated multimedia messaging. It also retrieves the address of service server 113 and can communicate with that server through data network 3, 114, via path 115. In one embodiment, service identity database 110 has a message associated with the service dialed number that can be used to reply to subscriber 100. In alternate embodiments, push server 108 retrieves these messages from service server 113.

If the service requires a voice callback to the subscriber, then push server 108 transfers control to service server 113 and ends the session and creates a log. If the service is a data service, then push server 108 uses data network 2, 110, to communicate to messaging gateway 111 to send the message via path 112 to mobile subscriber 100. This message can be a text message, a text message with embedded phone number or Internet address, or a message to instruct mobile device 101 to connect to service server 113, such as a WAP push. If the message is a text or multimedia message, then the service may not require or give subscriber 100 the option to reply. For example, a list of movies and show times may be what subscriber 100 desires. In other cases, subscriber 100 may have the option to reply; for example, to get driving directions to a theater. If a two-way messaging session is supported by service server 113 and mobile device 101, then, in one embodiment, the return address of the message received by subscriber 100 is the address of service server 113, and network gateway 116 has the same properties as messaging gateway 111. In an alternate embodiment, subscriber 100 replies via path 112 through digital wireless network 103 through messaging gateway 111 through data network 2, 110, to push server 108. Push server 108 then relays this reply via path 115 through data network 3, 114, to service server 113. This process is repeated in reverse for a continued dialogue. In yet another alternate embodiment, initial reply message 112 is sent directly from service server 113.

Mobile devices are capable of initiating an outgoing connection in multiple ways. A reply to a SMS message for a two-way SMS mobile device uses paths 117 and 118 to service server 113. A phone equipped with a WAP browser may accept a WAP alert from a network. When the user of the phone selects this alert, the phone connects to a WAP site designated in the alert via path 117 and receives a reply via path 118. Many phones can also parse an SMS message and allow the user to dial an embedded phone number or connect to an embedded URL by pressing “send.” Others may allow a phone user to manually select an embedded phone number or URL in a manner similar to the manner in which one selects a hypertext link with a PC web browser. If the reply is a digital message that involves the initiation of a interactive session with a different format than the original message, such as a WAP or HTML session, then mobile device 101 connects directly to service server 113 via path 118 through digital wireless network 103, network gateway 116, and data network 114. If the action taken by subscriber 100 is to initiate a voice call in response to the message, then mobile device 101 creates a voice call to an IVR service managed by service server 113. In one embodiment, network gateway 116 is a VXML server that manages the IVR session. In an alternate embodiment, network gateway 116 may be an integrated or distributed CTI system, where the service server 113 may be integrated with a network gateway that terminates the voice call. In an alternate embodiment, service server 113 may signal the PSTN or a local Private Branch Exchange (“PBX”) to connect the call directly to human operator 119 or a call center managing multiple human operators. In an alternate embodiment, the number provided to mobile subscriber 100 is the direct dial number of human operator 119 or a call center.

In lieu of a digital message as the call back, the service may choose to respond to subscriber 100 with a voice call back. Service server 113 may also initiate a voice callback to mobile subscriber 100 by creating an outbound call to mobile subscriber 100. In one embodiment, this is done with a VXML server as network gateway 116. In an alternate embodiment, this is done with an integrated or distributed CTI system, where service server 113 may be integrated with a network gateway that places the voice call. In an alternate embodiment, service server 113 may signal human operator 119, or a call center managing multiple human operators, to place the call.

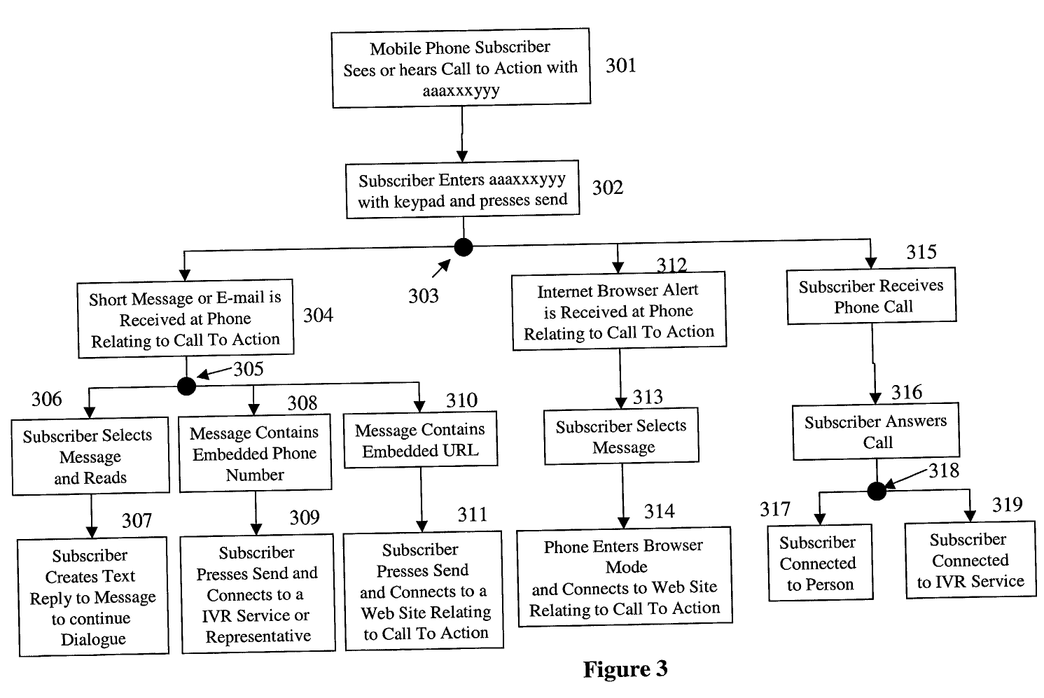

FIG. 3 is a flow diagram of one embodiment of a process of a mobile subscriber initiating and using the mobile service callback The process is performed by processing logic that may comprise hardware (e.g., circuitry, deductive logic, etc.), software (such as is executed on a general purpose computer system or a dedicated machine), or a combination of both. Referring to FIG. 3, the process begins in processing block 301 and processing block 302. In processing block 301, media 102 stimulates mobile subscriber 100 with call to action 206 and embedded service dialed number. Mobile subscriber 100 uses the mobile device 101 to enter the service dialed number and initiate the call in processing block 302. The action of pressing “send” initiates an outbound voice call in processing block 302 that is transmitted to digital wireless network 103. Mobile device 101 then returns to the wait state as the call is terminated, before answering, by network CTI system 105. Push server 108, in conjunction with service server 113, then makes the decision 303 on what type of callback is executed. Mobile subscriber 100 needs not act or intervene.

If a text, multimedia or e-mail message is sent, then mobile subscriber 100 receives the message on mobile device 101 in processing block 304. Push server 108, in conjunction with service server 113, then makes decision 305 that determines the contents of the message and the subsequent subscriber 100 experience. If the message contains no embedded links (e.g. the message is a text message), then subscriber 100 selects the message and reads it in processing block 306. If the message requires a reply and mobile device 101 supports reply messaging, then subscriber 100 creates a text message and replies in processing block 307. If the message contains an embedded phone number as a reply link and mobile device 101 supports extracting a phone number using the “send” button, then subscriber 100 presses “send” in processing block 309 and connects to the service. If, in processing block 310, the message contains an embedded URL or other internet address, then subscriber 100 presses “send” and is connected in processing block 311 to a web site provided by service server 113. In one embodiment, subscriber 100 presses “send” to connect to the web; a feature of his mobile device 101. In an alternate embodiment, subscriber 100 selects a link similar to a hypertext web link. The web link may contain unique identifiers to pass the identity of subscriber 100 and the source of the original stimuli 102.

If decision process 303 creates, in processing block 312, a message that is an Internet alert, such as a WAP alert, then an alert message is sent. Subscriber 100 selects the message in processing block 313 and, in processing block 314, mobile device 101 then connects subscriber 100 directly to a web site provided by service server 113.

If decision process 303 determines that a phone call back is required, then mobile subscriber 100 receives a phone call in processing block 315 and answers that phone call in processing block 316. Service server 113 makes decision 318, based on the characteristics of the service and, possibly, operator availability, whether to connect to a human in processing block 317 or an IVR system in processing block 319.

It should be noted that, in one embodiment, mobile subscriber 100 utilizes mobile device 101 in a manner similar to the way he uses the device to talk, receive messages, and browse, as defined by the capabilities of the device.

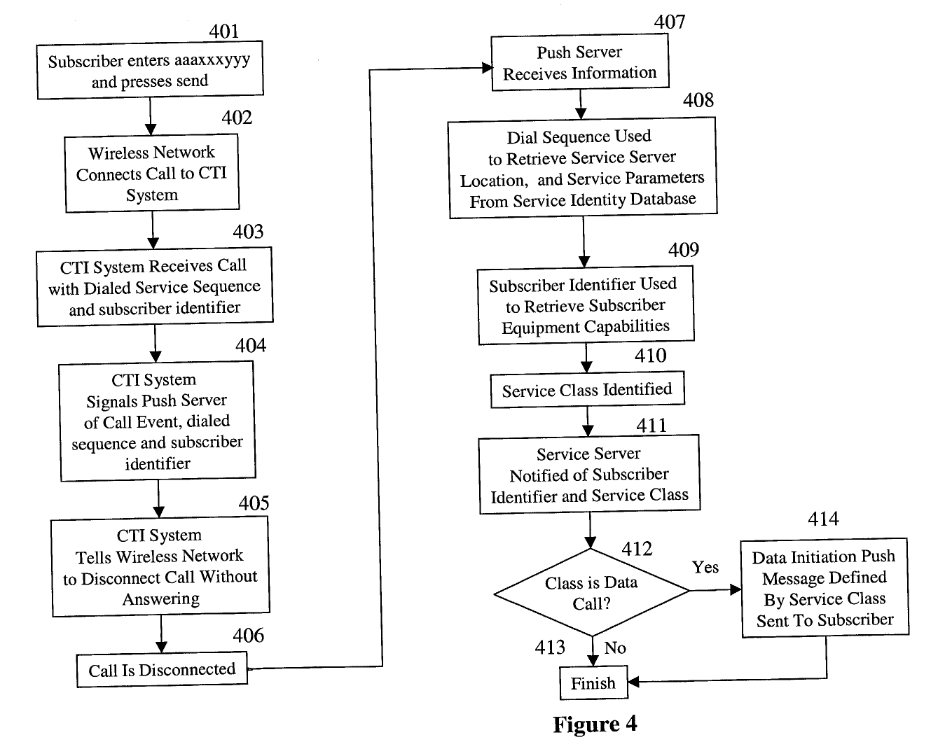

FIG. 4 is a flow diagram depicting one embodiment of a process performed by the Computer Telephony Integrated (“CTI”) and the push server components to connect a mobile device to a two-way dialogue through the action of a return data message. The contact from mobile subscriber 100 is initiated by subscriber 100 entering the service dialed number in mobile device 101 in processing block 401. This creates a call, through digital wireless network 103, that is routed to network CTI system 105 in processing block 402. CTI system 105 receives the service dialed number and the subscriber identifier as part of the incoming call information passed by the digital communications network in processing block 403. In processing block 404, network CTI system 105 then signals push server 108, via path 107 through digital network 1, 106, and passes the service dialed number and the subscriber identifier. In processing block 405, network CTI system 105 instructs digital wireless network 402 to disconnect the call, without answering, through the digital-signaling channel. In processing block 406, the call is disconnected.

Push server 108 receives the notification from CTI Server 105 in processing block 407. In processing block 407, CTI Server 105 passes, via path 107, the service dialed number and the subscriber identifier. In processing block 408, the service dialed number is used to retrieve the service parameters from service identity database 110. These service parameters may include, but are not limited to, the address of service server 113 associated with the service, a tabular field that specifies what type of callback is associated with the service for different subscriber mobile device capabilities, and a set of messages, each of which corresponds to a type of response and type of device to be sent to subscriber 100. For example, service identity database 110 may provide for a SMS text message, a multimedia message, and a WAP push for text-only screens, and a WAP push for graphical screens. In an alternate embodiment, service server 113, in response to a request from the push server, dynamically generates these messages and provides these capabilities, in real time, to push server 108. In yet another alternate embodiment, service server 113 sends the message directly to subscriber 100. One embodiment supports including details of the profile of subscriber 100 in determining the response to subscriber 100. For example, a personal return call may be used as a response for premium subscribers, and a data session may be used a response for unknown subscribers.

The subscriber equipment capabilities are retrieved, based on the subscriber identifier, from a database. The database entry for the subscriber 100 may be provided by the carrier. The database entry may be created by the service push database, through a variety of mechanisms, for an unknown subscriber. One approach is to send subscriber 100 a set of messages and observe the response type. Another approach is to connect subscriber 100 to a voice system and ask him for information. Yet another approach is to find specific details about mobile device 101 when mobile device 101 is connected to an Internet server; the identity of the device type is one of the fields passed in an HTML header during WAP browsing. Once the service and parameters are known, a service class that specifies the type of service, described above with reference to FIG. 3, is determined in processing block 410. In an alternate embodiment, service server 113 is asked for the service class. Service server 113 is then notified of the subscriber identifier and service class in processing block 411. This allows service server 113 to be prepared for a data callback, if required. A decision, based on whether the call back is data, is made in processing block 412. If a data message is to be sent, then the appropriate message is created and sent in processing block 414. If not, then the voice call back is made by service server 113, and push server 108 has no further actions, in processing block 413. In an alternate embodiment, push server 108 can initiate the voice call back and transfer the call to the service server or a person. In FIG. 4, “database” refers to a logical data archive searchable by the service dialed number or subscriber identifier. It may be that there are multiple physical databases or sources that comprise the logical databases.

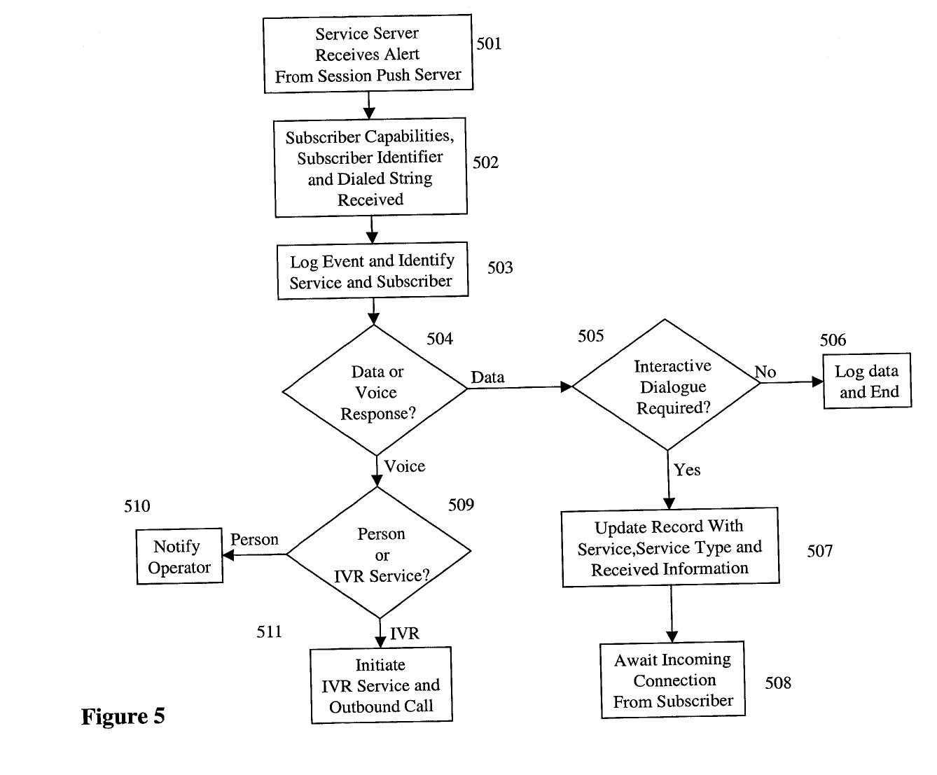

FIG. 5 illustrates a flow diagram of one embodiment of a process performed by service server 113. Service server 113 receives an alert, in processing block 501, from push server 108, that a response has been made by a subscriber, and that an action has been taken by push server 108. Service server 113 receives, in processing block 502, the information known to push server 108, consisting of the service dialed number, the subscriber identifier, the subscriber capabilities, and the service class, as determined in processing block 410 above. This event is logged and stored, in processing block 503, in anticipation of the callback sequence initiation. The action of service server 113 varies, depending on whether the service involves voice or data, in decision block 504. If data, then a further decision is made, in decision block 505, whether a response from subscriber 100 is expected in response to the message delivered by push server 108. If the response is not expected, then the event is logged in processing block 506 and this session ends. If a response is anticipated, then the subscriber record is updated, in processing block 507, with the information obtained from push server 108, and any other information retrieved or calculated from those data, in anticipation of the incoming query from subscriber 100. Service server 113 then awaits, in processing block 508, the message from subscriber 100 and the initiation of a two-way dialogue. If the service class is a voice call with a callback to be initiated by service server 113 (as in processing block 413 above, the voice callback is not initiated by the push server), then service server 113 first determines, in decision block 509, if the service class requires an IVR or a call to a person. If a person is to be notified, then a person is notified, in processing block 510, through an electronic mechanism, such as, for example, a screen pop-up created by embedded software, or an instant message. In one embodiment, multiple people are notified, and the call is taken by the first person to accept the call. In another embodiment, an entry to make the call is placed in a call center queue. If the call is to be an IVR call, then service server 113 initiates the IVR call and service server 113 manages the call.

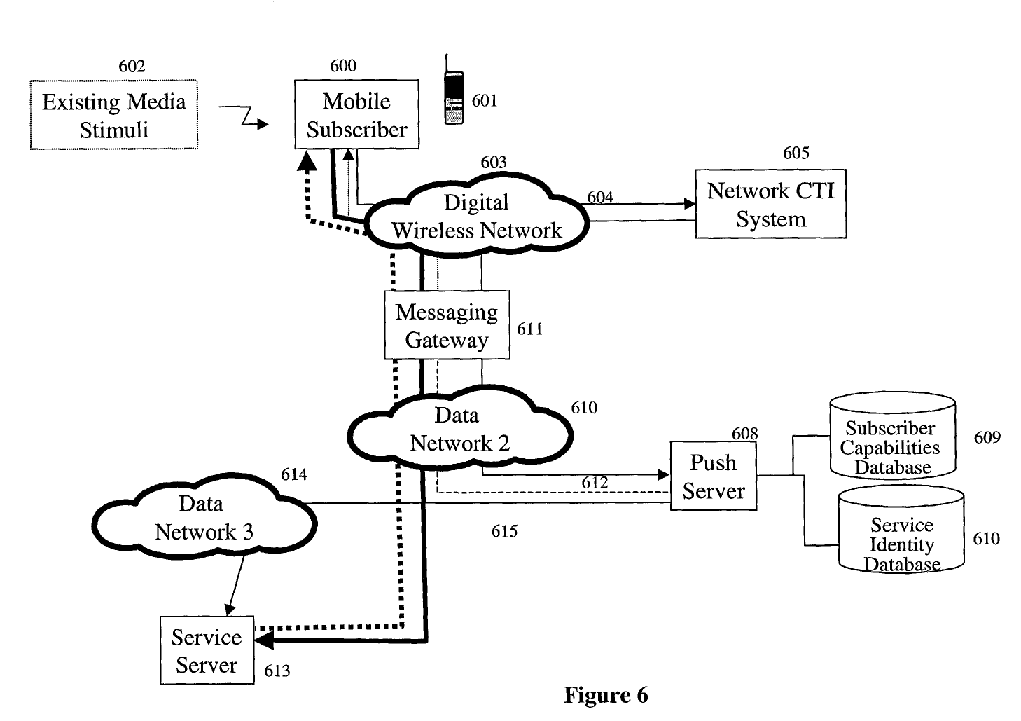

To illustrate how the service of FIGS. 1-5 may be realized, one embodiment of the service is presented in FIG. 6. Existing media stimuli 602 may include traditional print, radio, TV, and outdoor advertising associated with the release of a movie. Mobile subscribers 600 are subscribers of any of the cellular operators in a geographic location. The mobile devices 601 used are cell phones with 2-way SMS capabilities. The digital wireless network 603 is any of the operators' networks. The code used (“aaa”) is “*88”, and all of the operators agree to terminate the call in common network CTI system 605, which is a legacy voice response platform. In this case, CTI system 605 is connected to push server 608 via a network 610 used to carry SMS messages. The same network is used by push server 608 to reply to mobile subscriber 100 via use of the SMS system. As most subscribers have SMS capabilities, subscriber capabilities database 609 is a simple one, but is present to include future enhanced services. Service identity database 610 is used as described previously. Service server 614 communicates to push server 608 over an IP network, and can manage a conversation with subscriber 600 via SMS.

The method described above can be stored in the memory of a computer system as a set of instructions to be executed. In addition, the instructions to perform the method described above could alternatively be stored on other forms of machine-readable media, including magnetic and optical disks. For example, the method described herein could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods as discussed above, could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

While specific embodiments have been described, it is evident that numerous alternatives, modifications, and variation will be apparent to those skilled in the art in light of the foregoing description.

What is claimed is:

1. A method comprising:
receiving a call from a mobile device;
selecting, based upon information selected to address the call, a response to the call; and
initiating a dialog between a server and the mobile device.

2. The method of claim 1, further comprising:
terminating the call prior to an answering of the call.

3. The method of claim 1, further comprising:
determining, from the call, a subscriber identifier.

4. The method of claim 3, further comprising:
determining, based upon the subscriber identifier, a set of capabilities of the mobile device.

5. The method of claim 4, further comprising:
selecting, based upon the set of capabilities, a format, through which the mobile device is capable of communicating, for the dialog.

6. The method of claim 5, wherein the format is two-way SMS.

7. The method of claim 1, further comprising:
selecting, based upon a first subset of the information, the server to select the response.

8. The method of claim 1, further comprising:
identifying, based upon a second subset of the information, data independent of the server and a recipient of the call.

9. The method of claim 8, wherein the data is one of a product, a location, a person, and a group of people.

10. The method of claim 1, wherein the information may be selected through a standard cellular phone interface.

11. The method of claim 1, wherein the response instructs the mobile device to connect to the server.

10. A system comprising:
a network computer telephony integrated system to receive a call from a mobile device;
a service server to select, based upon information selected to address the call, a response to the call; and
a push server to initiate a dialog between the service server and the mobile device.

11. The system of claim 10, wherein the network computer telephony integrated system is to terminate the call prior to an answering of the call.

12. The system of claim 10, wherein the network computer telephony integrated system is to determine, from the call, a subscriber identifier.

13. The system of claim 12, wherein the push server is to determine, based upon the subscriber identifier, a set of capabilities of the mobile device.

14. The system of claim 13, wherein the push server is to select, based upon the set of capabilities, a format, through which the mobile device is capable of communicating, for the dialog.

15. The system of claim 14, wherein the format is two-way SMS.

16. The system of claim 10, wherein the push server is to select, based upon a first subset of the information, the service server to select the response.

17. The system of claim 16, wherein a second subset of the information identifies data independent of the service server and the network computer telephony integrated system.

18. The system of claim 17, wherein the data is one of a product, a location, a person, and a group of people.

19. The system of claim 10, wherein the information may be selected through a standard cellular phone interface.

20. The system of claim 10, wherein the response instructs the mobile device to connect to the service server.

21. A machine-readable medium that provides instructions that, when executed by a machine, cause the machine to perform operations comprising:
receiving a call from a mobile device; and
sending information about the call to a push server to initiate a dialog between a service server and the mobile device, the dialog to include a response to be selected based upon a information selected to address the call.

22. The machine-readable medium of claim 21, wherein operations further comprise:
terminating the call prior to an answering of the call.

23. The machine-readable medium of claim 21, wherein operations further comprise:
determining, from the call, a subscriber identifier.

24. The machine-readable medium of claim 21, wherein the information may be selected through a standard cellular phone interface.

25. A machine-readable medium that provides instructions that, when executed by a machine, cause the machine to perform operations comprising:
receiving, from a network computer telephony integrated system, data about a call received from a mobile device; and
initiating a dialog between a service server and the mobile device, the dialog to include a response to be selected based upon information selected to address the call.

26. The machine-readable medium of claim 25, wherein operations further comprise:
determining, based upon a subscriber identifier, a set of capabilities of the mobile device.

27. The machine-readable medium of claim 26, wherein operations further comprise:
selecting, based upon the set of capabilities, a format, through which the mobile device is capable of communicating, for the dialog.

28. The machine-readable medium of claim 27, wherein the format is two-way SMS.

29. The machine-readable medium of claim 25, wherein operations further comprise:
selecting, based upon a first subset of the information, a service server to select the response.

30. The machine-readable medium of claim 29, wherein operations further comprise:
identifying, based on a second subset of the information, a specification independent of the service server and the network computer telephony integrated system.

31. The machine-readable medium of claim 30, wherein the specification is one of a product, a location, a person, and a group of people.

32. A machine-readable medium that provides instructions that, when executed by a machine, cause the machine to perform operations comprising:
receiving a communication from a push server that received, from a network computer telephony integrated system, data about a call received from a mobile device; and
selecting a response, based upon information selected to address the call, to be included in a dialog to be initiated between a service server and the mobile device.

33. The machine-readable medium of claim 32, wherein the response instructs the mobile device to connect to the service server.

34. A system for the delivery of direct response to conventional advertising or other messaging by a mobile subscriber using a digital wireless network and a keypad on a mobile device that utilizes that digital wireless network, comprising:
a media stimulus, that is observed by the mobile subscriber, with an embedded call to action that includes a dial string to be entered by the mobile subscriber into the mobile device using the keypad of that device;
a network computer telephony integrated (CTI) system and associated executable computer code used to collect digits and the mobile subscriber's identity from network signaling associated with a voice call routed to that network CTI system by the digital wireless network and associated networks,
a push server and associated executable computer code that is signaled by the network CTI server and sends the mobile subscriber a digital message and communicates details of the service with a service server identified in a service identity database;
a subscriber capabilities database and the service identity database used by the push server to determine service type and service server identity that allows determination of service class to be provided to the mobile subscriber;
a set of service servers and associated executable computer code which provide an initial response delivered to the mobile subscriber by the push server and then control and conduct a two way service dialogue with the mobile subscriber;
a set of gateways which both translate data formats and addresses between the digital wireless network and other digital data networks as well as providing functionality required for delivery of the service to the mobile subscribers; and
a series of data networks that are used for communication between the mobile subscriber, network CTI system, push server, service server and gateways.

35. The system of claim 34, wherein the media stimulus is one of print advertising, TV advertising, and radio advertising.

36. The system of claim 34, wherein the stimulus is one of a printed card, pamphlet, and direct mail piece, wherein the stimulus delivered to the mobile subscriber.

37. The system of claim 34, wherein the stimulus is one of print and electronic display, wherein the stimulus is intended to be viewed by large numbers of the public in one of indoor spaces and outdoor spaces.

38. The system of claim 34, wherein the stimulus is printed on one of packaging of a physical object and a sticker affixed to packaging of a physical object.

39. The system of claim 34, wherein the stimulus is on one of an Internet site and Internet advertisement.

40. The system of claim 34, wherein the dial string comprises a unique dial number that corresponds to a PSTN network.

41. The system of claim 34, wherein the mobile device is one of a cell phone and a mobile phone.

42. The system of claim 34, wherein the mobile device is a Personal Digital Assistant with the ability to place voice phone calls.

43. The system of claim 34, wherein the keypad is a standard Dial Tone Multi Frequency (DTMF) keypad that is used to dial a phone call.

44. The system of claim 34, where the keypad is a soft screen based keypad that emulates a standard Dial Tone Multi Frequency (DTMF) keypad.

45. The system of claim 34, wherein voice recognition is used to connect to a number in the call to action by one of the mobile device and the digital wireless network.

46. The system of claim 34, wherein the mobile subscriber may use number storage capabilities of the mobile device after observing a media stimulus to bookmark the dial sequence and recall and connect capabilities of the mobile device to place the call.

47. The system of claim 34, wherein the network CTI system is connected to by the mobile subscriber and is connected directly to the digital wireless network, extracts the dial string and a mobile subscriber identifier and informs the push server.

48. The system of claim 47, wherein the network CTI system is external to the digital wireless network and terminates the call without answering.

49. The system of claim 34, wherein the network CTI system is connected and interfaced via a signaling and transport control Applications Protocol Interface (API) to a digital packet signaling and transport network that is connected to one of the digital wireless network and a PSTN.

50. The system of claim 34, wherein the network CTI server communicates to the push server through a public packet network.

51. The system of claim 34, wherein the network CTI server communicates to the push server through a private data network that may be part of the digital wireless network.

52. The system of claim 34, wherein the push server uses a service identity database and a subscriber capabilities database to determine the classes of service to be delivered to the mobile subscriber.

53. The system of claim 34, wherein the subscriber capabilities database is obtained from an operator of the digital wireless network.

54. The system of claim 34, wherein the subscriber capabilities database is obtained by sending multiple message formats to the mobile subscriber and observing a response.

55. The system of claim 34, wherein the subscriber capabilities database is obtained by asking the mobile subscriber via a method supported by all subscribers.

56. The system of claim 34, wherein the subscriber capabilities database is obtained from an Internet session with the subscriber using a standard Internet terminal and browser, wherein the standard Internet terminal is one of wired and wireless.

57. The system of claim 34, wherein the service class corresponds to one of a one way Short Message Service (SMS), a multimedia message, two way SMS, initiation of a mobile browser session via Wireless Application Protocol (WAP) push, initiation of a mobile browser session via embedding a URL in an SMS or e-mail message, initiation of a voice call with a voice number embedded in an SMS, a voice callback from a Interactive Voice Response (IVR) system, or a voice callback by a human operator.

58. The system of claim 34, wherein the push server uses the service identity database, the subscriber capabilities database, and a request from the service server to determine the class of service to be delivered to the mobile subscriber.

59. The system of claim 34, wherein the service class corresponds to one of one way Short Message Service (SMS), two way SMS, initiation of a mobile browser session via Wireless Application Protocol (WAP) push, initiation of a mobile browser session via embedding a URL in a SMS or e-mail message, a voice callback from an Interactive Voice Response (IVR) system, and a voice callback by a human operator.

60. The system of claim 34, wherein the push server returns an SMS message through an SMS gateway with a return SMS address, to be used by the mobile subscriber, that corresponds to an address of the push server.

61. The system of claim 34, wherein the push server returns an SMS message through an SMS gateway with a return SMS address, to be used by the mobile subscriber, that corresponds to an address of the service server.

62. The system of claim 34, wherein the push server returns a WAP push message through a WAP push gateway with a return address, to be used by the mobile subscriber, that corresponds to an address of the service server.

63. The system of claim 34, wherein the push server returns a SMS message through a SMS gateway, with one of an embedded phone number and an Internet Universal Resource Locator (URL), which corresponds to an addresses of the service server, to be used by the mobile subscriber.

64. The system of claim 34, wherein a message returned to the mobile subscriber is sent by the service server after communication with the push server.

65. The system of claim 34, wherein the push server informs the service server of a mobile subscriber event, the dial string, and an identity of the mobile subscriber.

66. The system of claim 34, wherein the push server determines the service class based on stored information in the service identity database and the mobile subscriber capabilities database, and informs the service server of the service class.

67. The system of claim 34, wherein the push server requests and receives the service class from the service server.

68. The system of claim 34, wherein the push server does not respond to the mobile subscriber and informs the service server that the service class is to make one of a return IVR and an operator phone call.

69. The system of claim 34, wherein the service class is delivered through use of a Voice Extensible Markup Language (VXM) gateway interfaced to the service server.

70. The system of claim 34, wherein the service class is delivered through use of a computer telephony integrated (CTI) platform interfaced to the service server.

71. The system of claim 34, wherein an operator-returned phone call is initiated by the service server directly contacting one or more human operators.

72. The system of claim 34, wherein an operator-returned phone call is initiated by the service server contacting a call center system which manages multiple operators.

73. The system of claim 72, wherein the operator-returned phone call consists of voice communication.

74. The system of claim 72, wherein the operator-returned phone call consists of text chat.

75. The system of claim 72, wherein the operator-returned phone call consists of multimedia communications.
